(19) United States
(12) Patent Application Publication
(10) Pub. No.: US 2008/0046997 A1
(43) Pub. Date: Feb. 21, 2008

(54) Data safe box enforced by a storage device controller on a per-region basis for improved computer security

(75) Inventor: Wenwei Wang, Allen, TX (US)

Correspondence Address: WENWEI WANG, 5003 Cedar Spring Drive, Missouri City, TX, 77459, US

(73) Assignee: GUARDTEC INDUSTRIES, LLC, Allen, TX (US)

(21) Appl. No.: 11/671,520

(22) Filed: Mar. 8, 2007

Related U.S. Application Data
(63) Continuation-in-part of application No. 11/539,930, filed on Oct. 10, 2006, now abandoned.
(60) Provisional application No. 60/822,946, filed on Aug. 21, 2006.

(51) Int. Cl. G06F 12/14

(52) U.S. Cl. 726/16

(57) ABSTRACT

A storage device comprises a storage device controller, a storage space, and a storage interface coupled to at least one computer system. The storage space is partitioned into a single or a plurality of regions, at least one of which is configurable to be associated with a protected access mode (read and/or write protect mode) through a configuration program (preferably password-protected). Whenever the storage device receives a data access request from a computer system, the storage device controller rejects the request if it determines that a portion or the entirety of a logical address range of the requested data block locates in a region associated with a protected access mode prohibiting the request. A region associated with a read-and-write-protect mode is a data safe box, wherein confidential and/or private and/or valuable data can be stored and protected against any accidental or malicious disclosure or tampering by a malicious program or an intruder.

### PRIORITY

This application is a continuation-in-part application of U.S. patent application Ser. No. 11/539,930 filed on Oct. 10, 2006, which further claims priority based on 35 USC 119 and U.S. provisional application 60/822,946 filed on Aug. 21, 2006.

### BACKGROUND OF THE INVENTION

1. Field of the Invention

This invention relates in general to computer systems and, more particularly, to systems and methods for protecting the integrity and/or the confidentiality of data stored in a single or a plurality of storage regions of a rewritable digital data storage device, which is accessible to a single or a plurality of computer systems, against any accidental or malicious attacks.

2. Description of Related Technology

A computer storage device (such as a hard disk drive, or a solid state disk drive, etc), provides nonvolatile mass data storage for a single or a plurality of computer systems. The storage device can be either internal or external to the computer system(s); and it can remotely communicate with the computer system(s) via a network. With correct access commands, the storage device allows full access to its stored data in the form of either reading data from it or writing (including erasing or deleting) data to it. Sometimes, a storage device may provide a manually operated write-protect switch; however, such type of write-protection applies to the entire storage space, but not to any particular area within the storage space; and the write-protection is not configurable, and is more common in portable storage devices.

One common technology for data security is relying upon an operating system in a computer system to do access control of data stored in a storage device. One common scheme is called a file system. From the standpoint of a file system, there are many possible access modes such as full-access mode, read-only mode, execute mode, hidden mode, etc. The data in the storage device may include not only programs (including operating system(s)) and data files, but also partition table(s), boot record information, boot code, metadata, file allocation table(s), and the like. However, there are always some security holes or vulnerabilities in an operating system that hackers may exploit; and subsequently even the operating system itself cannot be immune from numerous malicious attacks from worms, viruses, Trojan horses, spyware, adware, and other malicious software (collectively known as malware). And consequently, data in the storage device is under constant threats, especially when the storage device is directly or indirectly connected to a network.

Another common technology for data security is the application of various anti-malware and firewall software. One limitation is that end users ought to keep their anti-malware and firewall software periodically updated as new malware is identified on a daily basis. The other problem is that even the anti-malware or firewall software itself may contain vulnerabilities that hackers may exploit to take over control of the computers of victims.

Yet another common technology for data security is the application of various encryption technologies. By encrypting data (such as a file, or a directory, or a logical drive, or even an entire storage space, etc) in a storage subsystem, the confidentiality and privacy of data (especially data at rest) can be protected to considerable extent. However, the integrity of encrypted data may still be damaged (by ways of tampering, deleting, erasing, etc) by malicious or accidental attacks from malware, human errors, etc; and the data may still be stolen after the encrypted data is decrypted for any purposes such as reviewing, editing, etc.

Facing the increasing threat of data security, the information technology (IT) industry has been trying to implement a new security scheme called Trusted Computing, which is based upon a hardware device called Trusted Platform Module (TPM). TPM stores keys, digital certificates and passwords, and the like; and it can independently monitor and control all programs, which include malicious programs, to thereby protect a computer against malicious attacks, virtual or physical theft, and loss. However, trusted computing has limitations and it cannot solve all computer insecurity problems.

Several technologies are disclosed addressing various aspects of data security issues using different approaches. U.S. Pat. No. 7,130,971 (Kitamura) discloses a data access protection scheme enforced by a storage array controller coupled to a plurality of storage devices. U.S. Pat. No. 7,054,990 (Tamura et al.) discloses a method of accessing a protected area in an external storage by way of authentication of a password. U.S. Pat. No. 6,901,493 (Maffezzoni) discloses a file backup scheme for handling operating system crashes or data file corruptions. U.S. Pat. No. 6,802,029 (Shen et al.) discloses an alternative storage location where any access to data in a protected storage location is re-directed. U.S. Pat. No. 6,378,074 (Tiong) discloses a plurality of computing modes, each of which has its own storage and communication means. U.S. Pat. No. 6,336,187 (Kern et al.) discloses a storage security method to restrict every read or write access to a protected storage region (designated by a region identification instead of specific data block address) by way of checking a reference key. U.S. Pat. No. 6,272,533 (Browne) discloses a switching scheme for two computer systems to access a shared mass storage device in a conventional way or in a secure way. U.S. Pat. No. 6,185,661 (Ofek et al.) discloses a Write Once Read Many (WORM) magnetic storage device enforcing a read-only mode for a selected group of storage tracks from a system cache memory. U.S. Pat. No. 5,657,445 (Pearce) discloses a computer processor that can execute code in an operational mode or a system management mode, in which any access to protected regions of storage is denied. U.S. Pat. No. 5,542,044 (Pope) discloses a main storage device and an auxiliary storage device, between which signals are selectively blocked as needed. U.S. Pat. No. 5,289,540 (Jones) discloses a security subsystem which controls access to auxiliary memory based upon authorization passwords. International Pat. No. JP2005032166 (Hideki) discloses a host computer which controls the accessibility of a plurality of storage in a network based upon an allocation control table. International Pat. No. GB2409057 (Frederick et al.) discloses a method which uses security authentication to control access to protected storage. International Pat. No. EP1564738 (Choi) discloses a method using a dedicated section table in a hard disk drive to protect master boot record and file allocation information.

None of the above patents and prior art, taken either singly or in combination, is seen to disclose the present invention.

### BRIEF SUMMARY OF THE INVENTION

Broadly speaking, the present invention leverages an internal controller of a storage device to enforce a bottom layer of data access protection as first line of defense to achieve significant improvement in protecting the integrity and/or the confidentiality of storage data against any accidental or malicious attacks from any malicious program or any intruder or the like.

More particularly, one embodiment of data access protection for a storage device is disclosed which comprises a storage device controller, a storage space, and a storage interface. The storage device can be locally or remotely accessed by a single or a plurality of computer systems via the storage interface. The storage interface is coupled to the storage device controller, which is further coupled to the storage space. The storage device controller, in addition to other tasks, controls data access to the storage space; and it includes a single or a plurality of microprocessors, memory and embedded software or firmware, and optionally some other logic circuitries. The storage interface provides a single or a plurality of interface ports, each of which is accessible to a single or a plurality of computer systems.

The storage space can be partitioned into a single or a plurality of regions, at least one of which is configurable to be associated with a protected access mode. The partitioning of the storage space may be recorded in a single or a plurality of copies of partition tables. A protected access mode may be a read-and-write-protect mode or a write-protect mode. The storage device controller is adapted to prohibit any read access and any write access to a region associated with a read-and-write-protect mode, and is adapted to prohibit any write access to a region associated with a write-protect mode. The storage device controller is adapted to enforce a protected access mode for a region through firmware, or logic circuitries, or the combination of both firmware and logic circuitries. Association of a protected access mode with a region is configurable through a configuration apparatus of data access protection.

One major novel concept introduced by the present invention is a data safe box, which is essentially a region associated with a read-and-write-protect mode enforced by the storage device controller. A data safe box can be used to stored confidential and/or private and/or valuable data that need to be accessed infrequently; and it advantageously protects both the confidentiality and integrity of stored data against any accidental or malicious disclosure or tampering by any malicious program or any intruder or the like. Locking a data safe box is a process of associating a region in the storage space with a read-and-write-protect mode enforced by the storage device controller; while unlocking the data safe box is a process of removing the association of read-and-write-protect mode with the region. Unlocking a data safe box is preferably password-protected.

In one embodiment, for each region associated with a protected access mode enforced by the storage device controller, a currently active operating system running in a computer system accessing the storage device is adapted to enforce equivalent data access protection for the region on the operating system level.

The basic methodology of the present invention can be summarized as the following: when the storage device controller receives an access request from a computer system to read or write a data block from or to some location in the storage space, if the storage device controller is adapted to determine that a portion or the entirety of a logical address range of the data block locates in a region which is associated with a protected access mode prohibiting the access request, the storage device controller is adapted to reject the access request; otherwise, the storage device controller may be adapted to execute the access request either unconditionally or contingent on the access request to further meet one or multiple other conditions. The storage device controller has at least three approaches to determining if a portion or the entirety of the logical address range of the data block of the access request locates in a region which is associated with a protected access mode prohibiting the access request. The first approach is by comparing the logical address range of the data block against a logical address range of each region which is associated with a protected access mode prohibiting the access request to determine if there is any address overlapping. The second approach is by, if the access request contains an identification of the region wherein the data block of the access request locates or targets, determining whether the identification is associated with a region which is associated with a protected access mode prohibiting the access request. The third approach is by, if there is only one single region in the storage space, determining whether the single region is associated with a protected access mode prohibiting the access request.

In one embodiment, the configuration apparatus of data access protection is a configuration program running in a computer system accessing the storage device. The configuration program is adapted to communicate with the storage device controller through a single or a plurality of configuration commands during a configuration process. An operating system, which includes a single or a plurality of storage device drivers, runs in the computer system and is adapted to support configuration of data access protection. The storage device controller is adapted to support and save and enforce configuration of data access protection. The configuration program is adapted to perform the following major functions: listing each configurable region and corresponding logical address range and/or corresponding region identification; displaying protected access mode for each region which is associated with a protected access mode; optionally associating a region which is not associated with any protected access mode with a protected access mode; optionally removing association of any protected access mode with a region which is associated with a protected access mode; optionally associating a region which is associated with a first protected access mode with a second protect access mode. For initial configuration, the configuration program is adapted to directly or indirectly retrieve the initial information regarding configurable region(s) from some source such as a partition table, or a storage management program, or a database management program, or an operating system, etc. In one embodiment, the configuration program is adapted to be used to configure a single or a plurality of other storage devices that the configuration program can communicate with. In another embodiment, the configuration program is adapted to be functionally integrated into a storage management program and/or a file browser program and/or the storage device driver(s) or the operating system. In another embodiment, the configuration program is adapted to recover data stored in each region associated with a protected access mode. In still another embodiment, the configuration program is adapted to be used to set up a single or a plurality of configuration passwords or keys, one of which is required during a configuration process of data access protection. In still another embodiment, the configuration program is adapted to be used to set up different configuration passwords for access to different regions, each of which may be owned by a different user.

In one embodiment, if the storage interface provides a plurality of interface ports, the storage device controller is adapted to enforce a separate configuration of data access protection for storage data access via each of the interface ports.

In one embodiment, whenever a region is not associated with any protected access mode, the storage device controller is adapted to set partition type of the region in related partition table(s) of the storage space to an original partition type; whenever the region is associated with a particular protected access mode, the storage device controller is adapted to set partition type of the region in the related partition table(s) to a predefined partition type which represents the combination of the particular protected access mode and the original partition type.

In another embodiment, the storage device controller is adapted to monitor any change to partition type of each region in related partition table(s) of the storage space; if the storage device controller identifies that a first partition type of a region is changed to a second partition type representing a protected access mode, the storage device controller is adapted to enforce the protected access mode for the region. In another embodiment, the storage device controller is adapted to monitor any change to logical address range of each region in related partition table(s) of the storage space, if the storage device controller identifies that a first logical address range of a region is changed to a second logical address range, and if the region is associated with a protected access mode, the storage device controller is adapted to enforce the protected access mode for the region according to the second logical address range.

In another embodiment, whenever there is a region associated with a protected access mode, the storage device controller is adapted to associate each partition table with a write-protect mode; to modify a partition table associated with a write-protect mode, the configuration program is adapted to send a configuration command (preferably password-protected) to remove the association of write-protect mode with the partition table temporarily to enable modifying the partition table once.

In another embodiment, an external display is coupled to the storage device controller; the storage device controller is adapted to control the external display to indicate whether or not there is any region associated with a protected access mode.

In still another embodiment, a switch (preferably a pushbutton) is coupled to the storage device controller; asserting a switching signal through the switch enables the storage device controller to remove association of a protected access mode with a region.

In still another embodiment, a clock is coupled to the storage device controller; the storage device controller is adapted to periodically read time information from the clock to maintain association of a protected access mode with a region for a predetermined period of time. Potential application includes Write Once Read Many (WORM) digital data storage, etc.

The advantages and benefits of the present invention will become readily apparent upon further review of the following specifications and drawings.

### BRIEF DESCRIPTION OF THE DRAWINGS

FIG. 1 is a block diagram of the basic structure of a storage device accessible to at least one computer system wherein a configuration program of data access protection and an operating system are running according to the present invention.

FIG. 2 is a functional flowchart describing the basic methodology on how to implement data access protection enforced by a storage device controller according to the present invention.

FIG. 3 is a block diagram illustrating an external display coupled to a storage device controller for indicating whether or not there is any region associated with a protected access mode accordingly to the present invention.

FIG. 4 is a block diagram illustrating an external switch coupled to a storage device controller for manually enabling removing association of a protected access mode with a region accordingly to the present invention.

FIG. 5 is a block diagram illustrating a clock coupled to and controlled by a storage device controller for assisting the storage device controller to maintain association of a protected access mode with a region for a predetermined period of time accordingly to the present invention.

### DETAILED DESCRIPTION OF THE INVENTION

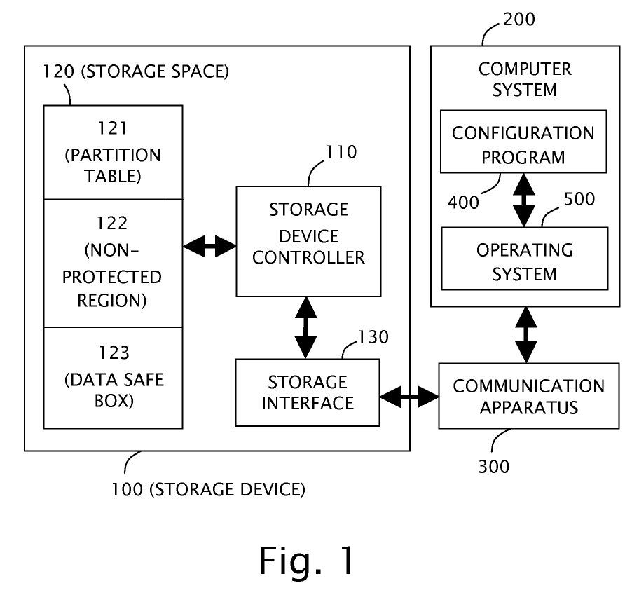

As illustrated in FIG. 1, a storage device 100 comprises a storage device controller 110, a storage space 120, and a storage interface 130. Storage device 100 can be locally or remotely accessed by at least one computer system 200 via some communication apparatus 300, which is coupled to storage interface 130. Storage interface 130 is coupled to storage device controller 110, which is further coupled to storage space 120. Storage device controller 110, in addition to other tasks, controls data access to storage space 120; storage device controller 110 includes a single or a plurality of microprocessors (each may contain a single or a plurality of central processing unit (CPU) cores), memory (optionally including read/write cache) and embedded software or firmware, and optionally some other logic circuitries. The memory in storage device controller 110 may include volatile memory (such as random access memory (RAM)) and nonvolatile memory (such as flash memory). Storage interface 130 provides a single or a plurality of interface ports, each of which is accessible to a single or a plurality of computer systems. Common communication technology for storage interface 130 includes Advanced Technology Architecture (ATA) which is either parallel ATA or serial ATA, Small Computer System Interface (SCSI) which is either parallel SCSI or serial SCSI, Fibre Channel (FC), Universal Serial Bus (USB), FireWire (or IEEE 1394), Ethernet, Peripheral Component Interface (PCI) bus (for applications such as bus-based storage device), etc. Communication apparatus 300 may be any individual or any combination of any wires and cables, any host bus adapter, any upstream storage controller, any switch, any multiplexer, any node, any grid, any expander, any upper-level storage system, any computer system, any gateway, any network (such as an internet protocol (IP) network, or a storage area network (SAN), etc), or the like that computer system 200 needs to pass through before it reaches storage device 100; and it may be wired, or wireless, or optical, or the like, or any combination thereof. Storage device 100 may contain other components for complete functionalities. For instance, if storage device 100 is a hard disk drive, it may contain a single or a plurality of read/write heads, a spindle motor, and a single or a plurality of head actuators, etc.

Storage device 100 may be a standalone storage system, or be integrated with a host computer system, or be combined with a single or a plurality of other storage devices to form a storage array (such as a Redundant Array of Independent Disks (RAID), or Just a Bunch of Disks (JBOD), or a Redundant Array of Independent Nodes (RAIN), or a heterogeneous disk array, etc). Storage device 100 can be in the form of a hard disk drive, or a solid-state disk drive (made of flash memory, or nonvolatile random access memory (NVRAM), or phase change memory, or any other solid-state nonvolatile memory), or a hybrid disk drive, or a tape drive, or a rewritable optical disk drive, or any other rewritable storage device.

A computer system, which accesses storage device 100, may be in the form of a supercomputer, or a mainframe computer, or a midrange computer, or a server, or a workstation, or a personal computer, or a personal digital assistant, or a smart mobile phone, etc. Storage device 100, optionally in conjunction with a single or a plurality of other storage devices, may be integrated with a host computer system to become a storage system in the form of a storage server, or a network attached storage (NAS) appliance, or an internet SCSI (iSCSI) appliance, or a SAN disk array, etc.

Storage space 120 can be partitioned into a single or a plurality of regions. The structure of the partitioning may be recorded in a single or a plurality of copies of partition tables, which may reside in storage space 120 and/or some nonvolatile memory accessible to storage device controller 110. A region may be in the form of a partition, or a logical drive, or a volume, or an extent, or a slice, or a data block, or the like. A partition table may be of any style such as a Master Boot Record (MBR) which includes some boot code, or a Globally Unique Identifier (GUID) Partition Table (GPT)), or the like; furthermore, for the purpose of data access protection, a partition table itself may be regarded as a special region. A partition type and a logical address range for each region are recorded in each partition table. Examples of a partition type include a File Allocation Table (FAT) partition, a New Technology File System (NTFS) partition, an Original Equipment Manufacturer (OEM) partition, an Extensible Firmware Interface (EFI) system partition, a data partition, a swap partition, a boot partition, a reserved partition, etc. A logical address range may be expressed as the combination of a starting logical address (or a relative offset address) and the length of the logical address range, or as the combination of a starting logical address and an ending logical address, or as any other appropriate format. One of the common units for a logical address is logical block addressing (LBA); each block unit may contain 512 bytes or more or fewer of data; actual addressing resolution may be up to a single byte level.

At least one region of storage space 120 is configurable to be associated with a protected access mode. A protected access mode may be a read-and-write-protect mode which is essentially a no-access mode, or a write-protect mode which is essentially a read-only mode. Storage device controller 110 is adapted to prohibit any read access and any write access (including any erase or delete operation) to a region which is associated with a read-and-write-protect mode; storage device controller 110 is adapted to prohibit any write access to a region which is associated with a write-protect mode. If there is any conflict between usage of a region and a particular protected access mode, the region is not configurable to be associated with the particular protected access mode. A protected region is a region associated with a protected access mode, while a non-protected region is a region not associated with any protected access mode. A data safe box is a protected region which is associated with a read-and-write-protect mode. As an example, FIG. 1 shows storage space 120 being partitioned into a non-protected region 122 and a data safe box 123; a partition table 121 records the partitioning. Storage device controller 110 is adapted to enforce a protected access mode for a region through firmware, or logic circuitries, or the combination of both firmware and logic circuitries. If storage device controller 110 contains any read/write cache, storage device controller 110 is adapted to maintain the consistency of data access protection between the read/write cache and storage space 120. Association of a protected access mode with a region is configurable: specifically, for a region not associated with any protected access mode, a protected access mode may be configured to be associated with the region; for a region associated with a protected access mode, the association of the protected access mode may be configured to be removed, or a different protected access mode may be configured to be associated with the region. Association of a protected access mode with a region is configurable through a configuration apparatus of data access protection.

A data safe box can be used to stored confidential and/or private and/or valuable data that need to be accessed infrequently; and it advantageously protects both the confidentiality and the integrity of stored data against any accidental or malicious disclosure or tampering by any malicious program or any intruder or the like. Examples of confidential data include tax returns and other financial information, business plans and analyses, backup copies of passwords, etc; examples of private data include personal emails, medical records, etc; examples of valuable data include any design documentation, photos, reports, or any other difficult-to-reproduce data. A data safe box is not designed to replace regular data backup. Locking or closing a data safe box is a process of associating a region in storage space 120 with a read-and-write-protect mode enforced by storage device controller 110; while unlocking or opening the data safe box is a process of removing the association of read-and-write-protect mode with the region; unlocking/opening the data safe box is preferably password-protected. As an application example, a user can create a single or a plurality of data safe box(es) in a laptop computer and store confidential and/or private and/or valuable data in the data safe box(es), so that the user can surf the internet or work on some other task(s) or be on a trip without concerning about the stored data being stolen or tampered by any malicious program or any intruder; in the event that the laptop compute is lost or stolen, data stored in the data safe box(es) cannot be accessed or tampered without a correct password, even if storage device 100 is detached and mounted onto a different computer.

It is not secure to enforce data access protection by an upper-stream storage controller (such as an ATA controller) connected to storage device 100. This is because that the upper-stream storage controller usually resides in a host computer system and subsequently when storage device 100 is detached from the host computer system, the upper stream storage controller can no longer enforce data access protection for storage device 100. Therefore, one critical security benefit of enforcing data access protection by storage device controller 110, which is internal to storage device 100, is that even if storage device 100 is detached and moved from one computer system to another, data access protection is still fully enforced by storage device controller 110.

In one embodiment, when a region is associated with a protected access mode, storage device controller 110 is adapted to prohibit updating firmware of storage device controller 110.

In another embodiment, a single or a plurality of regions of storage device 100 may be combined with a single or a plurality of regions of a single or a plurality of other storage devices to form a larger region (such as a database, etc) at a higher storage system level.

In another embodiment, to cope with gradual degradation of storage media of storage space 120 over a long term and thereby ensure the integrity of data stored in a region associated with a protected access mode, storage device controller 110 is adapted to check, preferably on a periodical basis, the health of storage space 120 and attempt to correct or remap any corrupted data in the region.

In still another embodiment, operating system files that require no or infrequent updates may be stored in a single or a plurality of regions, each of which is associated with a write-protect mode.

In still another embodiment, an anti-virus program is adapted to detect if there is any malicious program trying to access a region associated with a protected access mode; the anti-virus program is adapted to deter and remove the malicious program.

In yet another embodiment, to prevent any potential disclosure of stored data by directly reading storage media of storage space 120, data stored in a data safe box is preferably encrypted.

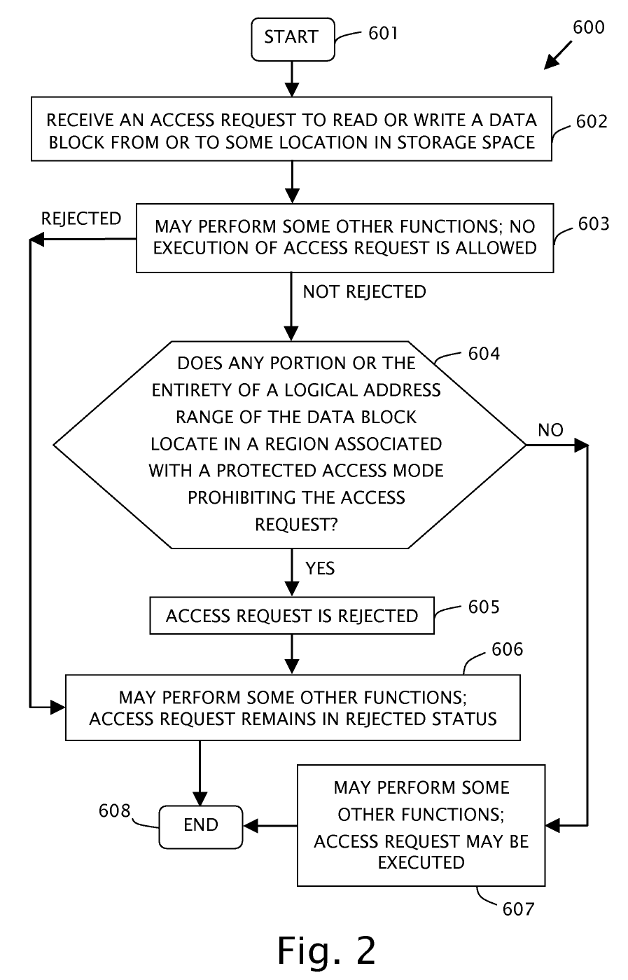

FIG. 2 illustrates the basic methodology of the present invention in a functional flowchart 600 carried out by storage device controller 110. Functional flowchart 600 begins with step 601. In step 602, storage device controller 110 receives an access request from a computer system to read or write a data block from or to some location in storage space 120. The size of the data block may be as small as one single byte. The access request may contain an identification of storage device 100. In step 603, storage device controller 110 may be adapted to perform some other functions; storage device controller 110 is adapted not to execute the access request, and it may be adapted to reject the access request based upon some preliminary condition(s); if the access request is rejected, functional flowchart 600 goes to step 606; otherwise, functional flowchart 600 goes to step 604. Steps 604 and 605 are related to the methodology of the present invention. More specifically, in step 604, if storage device controller 110 is adapted to determine that a portion or the entirety of a logical address range of the data block locates in a region which is associated with a protected access mode prohibiting the access request, functional flowchart 600 goes to step 605, wherein storage device controller 110 is adapted to reject the access request; otherwise, functional flowchart 600 goes to step 607, wherein storage device controller 110 may be adapted to perform some other functions, and may be adapted to execute the access request either unconditionally or contingent on the access request to further meet one or multiple other conditions (such as whether the logical address range of the data block locates within available storage space 120, etc), and then functional flowchart 600 ends in step 608. Step 605 is followed by step 606, wherein storage device controller 110 may be adapted to perform some other functions, but storage device controller 110 is adapted to maintain the access request in rejected status till functional flowchart 600 ends in step 608.

Still refer to step 604 in functional flowchart 600, storage device controller 110 has at least three approaches to determining if a portion or the entirety of the logical address range of the data block of the access request locates in a region which is associated with a protected access mode prohibiting the access request. The first approach is by comparing the logical address range of the data block against a logical address range of each region which is associated with a protected access mode prohibiting the access request; if there is any address overlapping, storage device controller 110 is adapted to reject the access request; otherwise, storage device controller 110 is adapted to execute the access request either unconditionally or contingent on the access request to further meet one or multiple other conditions. The second approach is by, if the access request contains an identification (such as drive “D”, or partition 3, or a partition GUID, etc) of the region wherein the data block of the access request locates or targets, determining whether the identification is associated with a region which is associated with a protected access mode prohibiting the access request; if it is true, storage device controller 110 is adapted to reject the access request; otherwise, storage device controller 110 is adapted to execute the access request either unconditionally or contingent on the access request to further meet one or multiple other conditions. The third approach is by, if there is only one single region in storage space 120, determining whether the single region is associated with a protected access mode prohibiting the access request; if it is true, storage device controller 110 is adapted to reject the access request; otherwise, storage device controller 110 is adapted to execute the access request either unconditionally or contingent on the access request to further meet one or multiple other conditions.

Still refer to FIG. 1, the configuration apparatus of data access protection is a configuration program 400 running in computer system 200. Either via a currently active operating system 500 running in computer system 200 or directly via a single or a plurality of storage device drivers (not shown in FIG. 1), configuration program 400 is adapted to communicate with storage device controller 110 through a single or a plurality of configuration commands during a configuration process. Operating system 500 may contain a single or a plurality of storage device drivers and other upper layers of storage management programs (such as partition manager, volume manager, file system, input/output (I/O) system, and the like) for controlling and managing storage device 100. Operating system 500, including the storage device driver(s), is adapted to support configuration of data access protection. Storage device controller 110 is adapted to support and enforce configuration of data access protection. Configuration program 400 is adapted to perform the following major functions: listing each configurable region and corresponding logical address range and/or corresponding region identification; displaying protected access mode for each region which is associated with a protected access mode; optionally associating a region which is not associated with any protected access mode with a protected access mode; optionally removing association of any protected access mode with a region which is associated with a protected access mode; optionally associating a region which is associated with a first protected access mode with a second protect access mode. For initial configuration, configuration program 400 may be adapted to directly or indirectly retrieve the initial information regarding configurable region(s) from a partition table, or a storage management program, or a database management program, or an operating system, etc. Storage device controller 110 is adapted to save configuration of data access protection to preferably some rewritable nonvolatile memory or some storage area in storage device 100. If configuration of data access protection is saved, storage device controller 110 is adapted to continue to enforce data access protection for each region associated with a protected access mode after a storage device 100 reboot. Storage device controller 110 is adapted to enforce configuration of data access protection for all subsequent storage data access requests until the configuration is modified again in the future. In one embodiment, configuration program 400 may be adapted to be used to configure a single or a plurality of other storage devices that configuration program 400 can communicate with. Configuration program 400 can be stored on any type of computer readable media such as a compact disc (CD), etc. In one embodiment, for ease of operation, configuration program 400 may be adapted to be functionally integrated into a storage management program, and/or a file browser program (such as Windows Explorer or Macintosh Finder, etc), and/or a single or a plurality of storage device drivers, or operating system 500, or the like. In another embodiment, configuration program 400 may be adapted to recover data stored in each region associated with a protected access mode in the event that a computer system crash or an operating system crash occurs.

Still refer to FIG. 1, in one embodiment, to prevent any accidental or malicious change of configuration of data access protection for a region associated with a protected access mode, through adaptation of configuration program 400, a configuration password or key may be set up. The configuration password optionally includes a single or a plurality of credentials such as a user name, etc. Storage device controller 110 is adapted to save a copy of the configuration password to preferably some nonvolatile memory or some storage area in storage device 100. Storage device controller 110 is adapted to require any subsequent configuration command for changing association of a protected access mode with any region to contain a copy of configuration password that matches the copy of configuration password saved in storage device 100; if the two configuration passwords do not match, storage device controller 110 is adapted to reject the configuration command. A configuration command containing a configuration password is essentially password-protected. Configuration program 400 is also adapted to be used to reset or change the configuration password. In one embodiment, in the likely event that the configuration password is lost, storage device controller 110 may be adapted to accept one recovery password, which may either be set up through configuration program 400 or be provided by a system manufacturer. In another embodiment, configuration program 400 may be adapted to be used to set up different configuration passwords for access to different regions, each of which may be owned by a different user.

Still refer to FIG. 1, in one embodiment, if storage interface 130 provides a plurality of interface ports, storage device controller 110 may be adapted to enforce a separate configuration of data access protection for storage data access via each of the interface ports. By way of example, a region may be configured to be associated with a write-protect mode if the region is accessed via an interface port, while the same region may be configured not to be associated with any protected access mode if the region is accessed via a different interface port.

In one embodiment, whenever a region is not associated with any protected access mode, storage device controller 110 is adapted to set partition type of the region in related partition table(s) of storage space 120 to an original partition type; whenever the region is associated with a particular protected access mode, storage device controller 110 is adapted to set partition type of the region in the related partition table(s) to a predefined partition type which represents the combination of the particular protected access mode and the original partition type. Specifically, whenever the region is associated with a read-and-write-and-protect mode, storage device controller 110 is adapted to set partition type of the region in the related partition table(s) to a first predefined partition type which represents the combination of read-and-write-protect mode and the original partition type; whenever the region is associated with a write-protect mode, storage device controller 110 is adapted to set partition type of the region in the related partition table(s) to a second predefined partition type which represents the combination of write-protect mode and the original partition type. In another embodiment, whenever a region is not associated with any protected access mode, the configuration apparatus of data access protection is adapted to send a single or a plurality of commands to storage device controller 110 to set partition type of the region in related partition table(s) to an original partition type recognizable by operating system 500; whenever the region is associated with a particular protected access mode, the configuration apparatus of data access protection is adapted to send a single or a plurality of commands to storage device controller 110 to set partition type of the region in the related partition table(s) to a predefined partition type recognizable by operating system 500 as a combination of the particular protected access mode and the original partition type. By way of example, if the original partition type of the region is a data partition, when the region is associated with a read-and-write-protect mode to become a data safe box, the partition type of the region is changed to a predefined partition type recognizable by operating system 500 as a combination of a data partition and a read-and-write-protect mode.

In another embodiment, storage device controller 110 is adapted to monitor any change to partition type of each region in related partition table(s) of storage space 120; if storage device controller 110 identifies that a first partition type of a region is changed to a second partition type representing a protected access mode, storage device controller 110 is adapted to enforce the protected access mode for the region. In another embodiment, storage device controller 110 is adapted to monitor any change to logical address range of each region in related partition table(s) of storage space 120, if storage device controller 110 identifies that a first logical address range of a region is changed to a second logical address range, and if the region is associated with a protected access mode, storage device controller 110 is adapted to enforce the protected access mode for the region according to the second logical address range.

In another embodiment, for each region associated with a protected access mode, storage device controller 110 is adapted to read the protected access mode by interpreting a partition type of the region in a partition table of storage space 120, and to copy the protected access mode to some volatile memory (such as RAM) accessible to storage device controller 110; furthermore, storage device controller 110 is adapted to read a logical address range of the region from the partition table, and to copy the logical address range to the volatile memory; storage device controller 110 is adapted to thereby enforce the protected access mode for the region based upon the protected access mode and the logical address range stored in the volatile memory.

In another embodiment, to prevent any accidental or malicious change to any partition table of storage space 120, whenever there is a region associated with a protected access mode, storage device controller 110 is adapted to associate each partition table with a write-protect mode; whenever there is no region associated with any protected access mode, storage device controller 110 is adapted to remove association of write-protect mode with any partition table. In order to modify a partition table which is associated with a write-protect mode, the configuration apparatus of data access protection is adapted to send a password-protected configuration command to storage device controller 110 to enable modifying the partition table once.

Still refer to FIG. 1, in one embodiment, for each region associated with a protected access mode enforced by storage device controller 110, operating system 500 running in computer system 200 accessing storage device 100 is adapted to enforce equivalent data access protection for the region on the operating system level. Specifically, if a region is associated with a read-and-write-protect mode enforced by storage device controller 110, operating system 500 is adapted to render the entire region as an inaccessible region; if the region is associated with a write-protect mode enforced by storage device controller 110, operating system 500 is adapted to render the region as a read-only region.

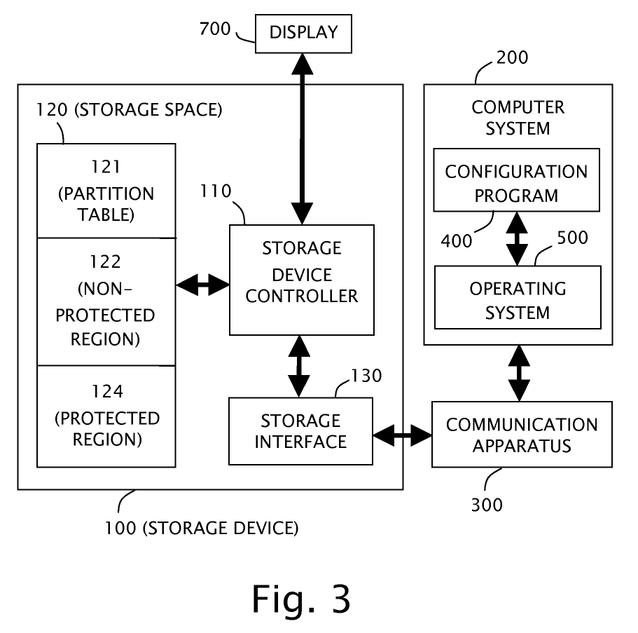

Refer to FIG. 3, in another embodiment, an external display 700 (such as light-emitting diode (LED) display) is coupled to storage device controller 110, which is adapted to control external display 700 to indicate whether or not there is any region associated with a protected access mode. FIG. 3 is similar to FIG. 1 except that region 123 (a data safe box) is replaced by a region 124 (a protected region) for showing potential application of display 700 to any region associated with a protected access mode.

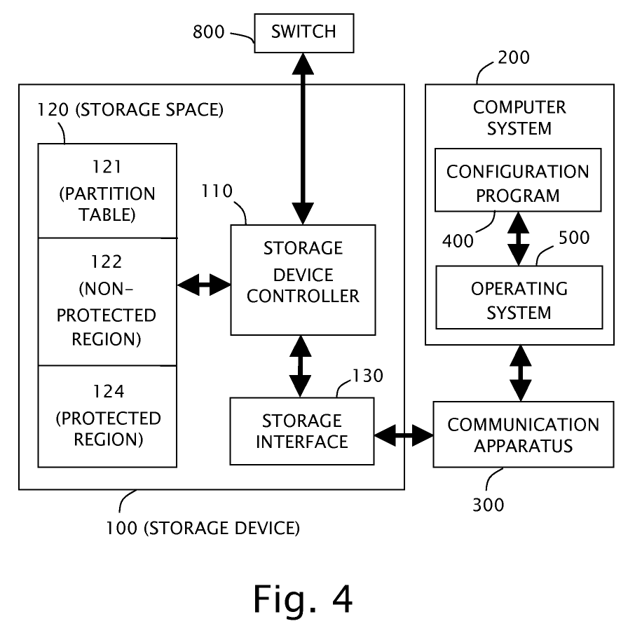

FIG. 4 is the same as FIG. 3 except that display 700 is replaced by a switch 800. Refer to FIG. 4, in another embodiment, switch 800 is coupled to storage device controller 110; before storage device controller 110 is adapted to be enabled to remove association of a protected access mode with a region, storage device controller 110 is adapted to wait for a switching signal from switch 800 to be asserted through manual operation; if the switching signal is not asserted within a predetermined period of time (such as 30 seconds), storage device controller 110 may be adapted to stop waiting for the switching signal and be adapted to continue to enforce the protected access mode for the region. Switch 800 is preferably a momentary pushbutton switch which asserts the switching signal when switch 800 is pressed upon, and which de-asserts the switching signal when switch 800 is released. Switch 800 is preferably installed on the exterior of storage device 100 or on the exterior of a host computer system which integrates storage device 100. In another embodiment, in order to save space and to be more intuitive in manual operation, switch 800 is preferably mechanically integrated with display 700 shown in FIG. 3. One application of adding switch 800 to data access protection is for preventing a malicious program (such as a keystroke logging virus) from attempting to remove association of a protected access mode with a region after the malicious program steals a configuration password of data access protection.

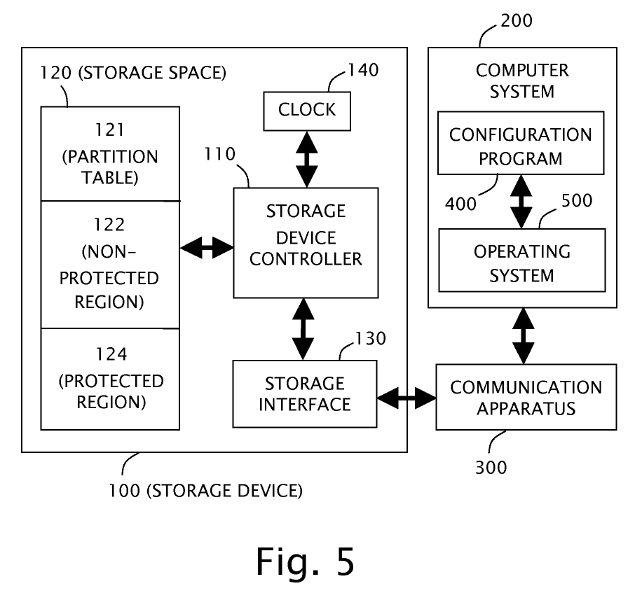

FIG. 5 is similar to FIG. 3 except that display 700 is replaced by a clock 140. Refer to FIG. 5, in still another embodiment, clock 140 is coupled to storage device controller 110, which is adapted to periodically read time information from clock 140 to maintain association of a protected access mode with a region for a predetermined period of time. Clock 140 may provide detailed time information such as year, month, day, hour, minute, and second, etc. Whenever a selected region is associated with a protected access mode, storage device controller 110 is adapted to read a starting time from clock 700 and save the starting time to some nonvolatile memory or some storage area in storage device 100; storage device controller 110 is adapted to maintain the protected access mode for the selected region for a predetermined period of time by periodically reading clock 700 and determining if an ending time is reached; when the ending time is reached (in other words, when the predetermined period of time expires), storage device controller 140 is adapted to remove association of the protected access mode with the selected region immediately. Potential application includes Write Once Read Many (WORM) digital data storage which protects and retains fixed data (such business records, financial transaction records, documents, emails, medical images, bank check images, etc) for extended period of time for regulatory governmental compliance as well as for corporate governance.

The present invention can find a number of applications in the IT industry. As an example, a database is saved in a single or a plurality of storage regions, each of which is subsequently associated with a write-protect mode enforced by storage device controller 110, to thereby create a storage-device-controller-enforced read-only database which is tamper-proof. As another example, all the for-read information on a website is saved in a single or a plurality of storage regions, each of which is subsequently associated with a write-protect mode enforced by storage device controller 110, to thereby create a storage-device-controller-enforced read-only website that cannot be defaced by any hacker.

While the foregoing invention shows a number of illustrative and descriptive embodiments of the invention, it will be apparent to any person with ordinary skills in the area of technology related to the present invention that various changes, modifications, substitutions and combinations can be made herein without departing from the scope or the spirit of the present invention as defined by the following claims.

What is claimed is:

1. A storage device accessible to a single or a plurality of computer systems, said storage device comprising:
a storage space being partitioned into a single or a plurality of regions, at least one of said regions being configurable to be associated with a protected access mode, said protected access mode being a read-and-write-protect mode or a write-protect mode, association of a protected access mode with a region being configurable through a configuration apparatus of data access protection;
a storage interface including a single or a plurality of interface ports, each of said interface ports being accessible to a single or a plurality of computer systems;
a storage device controller being coupled to said storage interface and said storage space, said storage device controller being adapted to control data access to said storage space, whenever said storage device controller receives a data access request from a computer system to read or write a data block from or to a location in said storage space, said storage device controller being adapted to reject said data access request if said storage device controller determines that a portion or the entirety of a logical address range of said data block locates in a region which is associated with a protected access mode prohibiting said data access request.

2. Said storage device of claim 1 wherein said storage device controller comprises a single or a plurality of microprocessors, memory and firmware, and optionally some other logic circuitries.

3. Said storage device of claim 1 wherein said storage device controller includes some read/write cache, said storage device controller is adapted to maintain consistency of data access protection between said read/write cache and said storage space.

4. Said storage device of claim 1 wherein said storage device controller is adapted to enforce a protected access mode for a region by way of firmware or logic circuitries or the combination of both firmware and logic circuitries.

5. Said storage device of claim 1 wherein a data safe box is a region which is associated with a read-and-write-protect mode.

6. Said storage device of claim 1 wherein said storage device is adapted to be a standalone storage system, or is adapted to be integrated with a host computer system, or is adapted to be combined with a single or a plurality of other storage devices to form a storage array.

7. Said storage device of claim 1 wherein an external display is coupled to said storage device controller, said storage device controller is adapted to control said external display to indicate whether or not there is any region associated with a protected access mode.

8. Said storage device of claim 1 wherein a switch is coupled to said storage device controller, and before said storage device controller is adapted to be enabled to remove association of a protected access mode with a region, said storage device controller is adapted to wait for a switching signal from said switch to be asserted through manual operation.

9. Said storage device of claim 1 wherein a clock is coupled to said storage device controller, said storage device controller is adapted to periodically read time information from said clock to maintain association of a protected access mode with a region for a predetermined period of time.

10. Said storage device of claim 1 wherein, whenever a region is not associated with any protected access mode, said storage device controller is adapted to set partition type of said region in related partition table(s) of said storage space to an original partition type, and whenever said region is associated with a particular protected access mode, said storage device controller is adapted to set partition type of said region in said related partition table(s) to a predefined partition type which represents a combination of said particular protected access mode and said original partition type.

11. Said storage device of claim 1 wherein said configuration apparatus of data access protection comprises a configuration program running in a host computer system accessing said storage device, said storage device controller is adapted to support and save and enforce configuration of data access protection, an operating system running in said host computer system is adapted to support said configuration of data access protection, said configuration program is optionally adapted to be used to set up a single or a plurality of configuration passwords for security.

12. Said storage device of claim 1 wherein, if said storage interface includes a plurality of interface ports, said storage device controller is adapted to be configured through said configuration apparatus of data access protection to enforce a separate configuration of data access protection for storage data access via each of said interface ports.

13. A computer system including a storage device which comprises:
a storage space being partitioned into a single or a plurality of regions, at least one of said regions being configurable to be associated with a protected access mode, said protected access mode being a read-and-write-protect mode or a write-protect mode, association of a protected access mode with a region being configurable through a configuration apparatus of data access protection;
a storage interface including a single or a plurality of interface ports, each of said interface ports being accessible to a single or a plurality of computer systems;
a storage device controller being coupled to said storage interface and said storage space, said storage device controller being adapted to control data access to said storage space, whenever said storage device controller receives a data access request from said computer system to read or write a data block from or to a location in said storage space, said storage device controller being adapted to reject said data access request if said storage device controller determines that a portion or the entirety of a logical address range of said data block locates in a region which is associated with a protected access mode prohibiting said data access request.

14. Said computer system of claim 13 wherein a data safe box is a region which is associated with a read-and-write-protect mode.

15. Said computer system of claim 13 wherein, whenever a region is not associated with any protected access mode, said storage device controller is adapted to set partition type of said region in related partition table(s) of said storage space to an original partition type, and whenever said region is associated with a particular protected access mode, said storage device controller is adapted to set partition type of said region in said related partition table(s) to a predefined partition type which represents a combination of said particular protected access mode and said original partition type.

16. Said computer system of claim 13 wherein said configuration apparatus of data access protection comprises a configuration program running in said computer system, said storage device controller is adapted to support and save and enforce configuration of data access protection, an operating system running in said computer system is adapted to support said configuration of data access protection, said configuration program is optionally adapted to be used to set up a single or a plurality of configuration passwords for security.

17. A method of data access protection for a storage device comprising a storage device controller and a storage space and a storage interface, said storage device being accessible to a single or a plurality of computer systems, said storage interface being coupled to said storage device controller and providing a single or a plurality of interface ports, said storage device controller being coupled to said storage space, said storage device controller being adapted to control data access to said storage space, said storage space being partitioned into a single or a plurality of regions, said method comprising:
at least one of said regions being configurable to be associated with a protected access mode, said protected access mode being a read-and-write-protect mode or a write-protect mode;
association of a protected access mode with a region being configurable through a configuration apparatus of data access protection;
whenever said storage device controller receives a data access request from a computer system to read or write a data block from or to a location in said storage space, said storage device controller being adapted to reject said data access request if said storage device controller determines that a portion or the entirety of a logical address range of said data block locates in a region which is associated with a protected access mode prohibiting said data access request.

18. Said method of claim 17 wherein said storage device controller is adapted to prohibit any read access and any write access to a region which is associated with a read-and-write-protect mode, said storage device controller is adapted to prohibit any write access to a region which is associated with a write-protect mode.

19. Said method of claim 17 wherein, if said storage device controller determines that neither any portion nor the entirety of said logical address range of said data block locates in any region which is associated with a protected access mode prohibiting said data access request, said storage device controller is adapted to execute said data access request either unconditionally or contingent on said data access request to further meet one or multiple other conditions.

20. Said method of claim 17 wherein said storage device controller is adapted to determine whether a portion or the entirety of said logical address range of said data block locates in a region which is associated with a protected access mode prohibiting said data access request by comparing said logical address range of said data block with a logical address range of each region associated with a protected access mode prohibiting said data access request, said storage device controller is adapted to reject said data access request if the comparison identifies an address overlapping between said data block and any region associated with a protected access mode prohibiting said data access request.

21. Said method of claim 17 wherein said storage device controller is adapted to determine whether a portion or the entirety of said logical address range of said data block locates in a region which is associated with a protected access mode prohibiting said data access request by, if said data access request includes an identification of the region wherein said data block locates or targets, determining whether said identification is associated with a region which is associated with a protected access mode prohibiting said data access request, said storage device controller is adapted to reject said data access request if said identification is associated with a region associated with a protected access mode prohibiting said data access request.

22. Said method of claim 17 wherein said storage device controller is adapted to determine whether a portion or the entirety of said logical address range of said data block locates in a region which is associated with a protected access mode prohibiting said data access request by, if there is only one single region in said storage space, determining whether said single region is associated with a protected access mode prohibiting said data access request, said storage device controller is adapted to reject said data access request if said single region is associated with a protected access mode prohibiting said data access request.

23. Said method of claim 17 wherein a single or a plurality of regions of said storage device are adapted to be combined with a single or a plurality of regions of a single or a plurality of other storage devices to form a larger region at a higher storage system level.

24. Said method of claim 17 wherein a data safe box is a region which is associated with a read-and-write-protect mode.

25. Claim 24 wherein data stored in said data safe box is encrypted.

26. Said method of claim 17 wherein for each region associated with a protected access mode enforced by said storage device controller, an operating system running in a computer system accessing said storage device is adapted to enforce equivalent data access protection for said region on said operating system level.

27. Claim 26 wherein, whenever a region is associated with a read-and-write-protect mode enforced by said storage device controller, said operating system is adapted to render said region as an inaccessible region, and whenever said region is associated with a write-protect mode enforced by said storage device controller, said operating system is adapted to render said region as a read-only region.

28. Said method of claim 17 wherein, whenever a region is associated with a protected access mode, said storage device controller is adapted to prohibit updating firmware of said storage device controller.

29. Said method of claim 17 wherein said storage device controller is adapted to periodically check the health of said storage space, said storage device controller is adapted to attempt to correct or remap any corrupted data in any region which is associated with a protected access mode.

30. Said method of claim 17 wherein an anti-virus program is adapted to detect if there is any malicious program trying to access a region which is associated with a protected access mode, said anti-virus program is adapted to deter and remove said malicious program.

31. Said method of claim 17 wherein, whenever a region is not associated with any protected access mode, said storage device controller is adapted to set partition type of said region in related partition table(s) of said storage space to an original partition type, and whenever said region is associated with a particular protected access mode, said storage device controller is adapted to set partition type of said region in said related partition table(s) to a predefined partition type which represents a combination of said particular protected access mode and said original partition type.

32. Claim 31 wherein for each region associated with a protected access mode, said storage device controller is adapted to read said protected access mode by interpreting a partition type of said region in a partition table of said storage space, said storage device controller is adapted to copy said protected access mode to some volatile memory accessible to said storage device controller, said storage device controller is adapted to read a logical address range of said region from said partition table, said storage device controller is adapted to copy said logical address range to said volatile memory, said storage device controller is adapted to thereby enforce said protected access mode for said region based upon said protected access mode and said logical address range stored in said volatile memory.

33. Claim 31 wherein said storage device controller is adapted to monitor any change to partition type of each region in said related partition table(s), and if said storage device controller identifies that a first partition type of a region is changed to a second partition type representing a protected access mode, said storage device controller is adapted to enforce said protected access mode for said region.

34. Claim 31 wherein said storage device controller is adapted to monitor any change to logical address range of each region in said partition table(s), and if said storage device controller identifies that a first logical address range of a region is changed to a second logical address range, and if said region is associated with a protected access mode, said storage device controller is adapted to enforce said protected access mode for said region according to said second logical address range.

35. Said method of claim 17 wherein, whenever a region is associated with a protected access mode, said storage device controller is adapted to prohibit modifying any partition table of said storage space.

36. Claim 35 wherein, whenever there is a region associated with a protected access mode, said storage device controller is adapted to associate each partition table of said storage space with a write-protect mode, and whenever there is no region associated with any protected access mode, said storage device controller is adapted to remove association of write-protect mode with any partition table of said storage space.

37. Claim 36 wherein, in order to modify a partition table which is associated with a write-protect mode, said configuration apparatus of data access protection is adapted to send a password-protected configuration command to said storage device controller to enable modifying said partition table once.

38. Said method of claim 17 wherein said configuration apparatus of data access protection comprises a configuration program running in a host computer system accessing said storage device, said configuration program is adapted to communicate with said storage device controller through a single or a plurality of configuration commands during a configuration process, said storage device controller is adapted to support and save and enforce configuration of data access protection, an operating system running in said host computer system includes a single or a plurality of storage device drivers, said operating system is adapted to support said configuration of data access protection.

39. Said configuration apparatus of data access protection of claim 38 wherein said configuration program is adapted to list each configurable region and corresponding logical address range and/or corresponding region identification, said configuration program is adapted to display protected access mode for each region which is associated with a protected access mode, said configuration program is adapted to optionally associate a region which is not associated with any protected access mode with a protected access mode, said configuration program is adapted to optionally remove association of any protected access mode with a region which is associated with a protected access mode, said configuration program is adapted to optionally associate a region which is associated with a first protected access mode with a second protect access mode.

40. Said configuration apparatus of data access protection of claim 38 wherein for initial configuration, said configuration program is adapted to directly or indirectly retrieve the initial information regarding configurable region(s) from a partition table or a storage management program or a database management program or an operating system.

41. Said configuration apparatus of data access protection of claim 38 wherein, whenever a region is not associated with any protected access mode, said configuration program is adapted to send a single or a plurality of configuration commands to said storage device controller to set partition type of said region in related partition table(s) of said storage space to an original partition type recognizable by said operating system, and whenever said region is associated with a particular protected access mode, said configuration program is adapted to send a single or a plurality of configuration commands to said storage device controller to set partition type of said region in said related partition table(s) to a predefined partition type recognizable by said operating system as a combination of said particular protected access mode and said original partition type.

42. Said configuration apparatus of data access protection of claim 38 wherein said configuration program is adapted to be functionally integrated into a storage management program and/or a file browser program and/or said storage device driver(s) or said operating system.

43. Said configuration apparatus of data access protection of claim 38 wherein said configuration program is adapted to recover data stored in each region associated with a protected access mode.

44. Said configuration apparatus of data access protection of claim 38 wherein said configuration program is adapted to be used to set up a configuration password which optionally includes a single or a plurality of credentials, said storage device controller is adapted to save a copy of said configuration password in said storage device, said storage device controller is adapted to require any subsequent configuration command for changing association of a protected access mode with any region to contain a matching copy of said configuration password, said storage device controller is adapted to reject said configuration command if said configuration command does not contain a matching copy of said configuration password.

45. Claim 44 wherein said configuration program is adapted to be used to set up different configuration passwords for access to different regions.

46. Claim 44 wherein in addition to said configuration password, said storage device controller is adapted to accept said configuration command if said configuration command contains a matching copy of a recovery configuration password, said recovery configuration password either is set up by said configuration program or is provided by a system manufacturer.

47. Said configuration apparatus of data access protection of claim 38 wherein said configuration program is adapted to be used to configure a single or a plurality of other storage devices that said configuration program communicates with.
